(19) United States
(12) Patent Application Publication
(10) Pub. No.: US 2010/0057572 A1
(43) Pub. Date: Mar. 4, 2010

(54) WEB SERVICES AND METHODS FOR SUPPORTING AN ELECTRONIC SIGNBOARD

(76) Inventors: Paul O. Scheibe, Arroyo Grande, CA (US); Jay B. Scheibe, Minden, NV (US)

Correspondence Address: Haynes and Boone, LLP;IP Section, 2323 Victory Avenue, SUITE 700, Dallas, TX, 75219, US

(21) Appl. No.: 12/198,252

(22) Filed: Aug. 26, 2008

(51) Int. Cl. G06Q 30/00

(52) U.S. Cl. 705/14.61; 705/14.64

(57) ABSTRACT

An advertising support system includes an operation center, numerous display systems and one or more client services systems. The operation center is a platform that provides a collection of services and capabilities. For example, the operation center is responsible for assuring that the content is displayed on the display systems at required times and locations. The system may accommodate multiple operation centers in multiple geographical locations to provide failure recovery and to provide services over geographically diverse locations. A variety of services are provided by the operation center to support its operations and the display systems. For example, the operation center populates and maintains a current and archival database, which includes status, content, fault and maintenance logs, and other data of display systems. Numerous services may be provided through the client services systems. The client services systems access the operation center through an operation center interface to obtain data necessary to support various application that can be provided under a web service. Applications include content information retrieval by client and customers, and the general public, and administrative services (e.g., accounting, maintenance and engineering).

### BACKGROUND OF THE INVENTION

1. Field of the Invention

The present invention relates to advertising using billboards. In particularly, the present invention relates to services that supports and extends services associated with electronic billboards.

2. Discussion of the Related Art

Network-enabled electronic billboards have become available within the last decade. A number of functional organizations of diverse interests, including accounting, engineering, content preparation, programming, and maintenance are involved in supporting the operations of such an electronic billboard. Therefore, an integrated system that provides services in real time, whether or not under controlled access, for content development, data retrieval and operational control for the electronic billboard is desired.

### SUMMARY

According to one embodiment of the present invention, an advertising support system includes an operation center, numerous display systems and one or more client services systems. The operation center is a platform that provides a collection of services and capabilities. For example, the operation center is responsible for ensuring that the content is displayed on the display systems at required times and locations. The present invention may accommodate multiple operation centers in multiple geographical locations to provide failure recovery and to provide services over geographically diverse locations. A variety of services are provided by the operation center to support its operations and the display systems. For example, the operation center populates and maintains a current and archival database, which includes status, content, fault and maintenance logs, and other data of the display systems.

Numerous services may be provided through the client services systems. In one embodiment, the client services systems access the operation center through an operation center interface to obtain or supply data necessary to support various applications that can be provided under a web service. Applications include content and information retrieval by clients, customers, and the general public, and administrative services (e.g., accounting, maintenance and engineering) for personnel in the operating center.

The present invention is better understood upon consideration of the detailed description below and the accompanying drawings.

### BRIEF DESCRIPTION OF THE DRAWINGS

FIG. 1 advertising support system 100, according to one embodiment of the present invention.

FIG. 2 shows, in further detail, the services and operations of operation center 101 of FIG. 1's advertising support system 100.

FIG. 3 shows exemplary services available in client services system 103, which provides access to data stored in operation center 101 of FIG. 1's advertising support system 100.

FIG. 4 provides an overview of the applications that can be provided under the web service, according to one embodiment of the present invention.

### DETAILED DESCRIPTION OF THE PREFERRED EMBODIMENTS

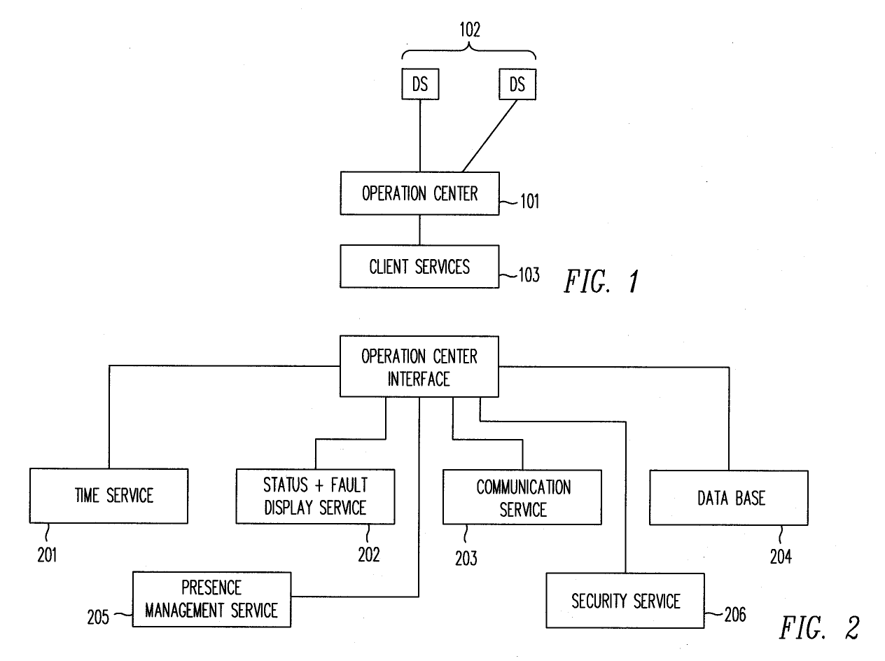

FIG. 1, shows according to one embodiment of the present invention, advertising support system 100, which includes operation center 101, numerous display systems 102, and client services system 103. Operation center 101 is a platform that provides a collection of services and capabilities. For example, operation center 101 is responsible for ensuring that the content is displayed on display systems 102 at required or designated times and locations. Although shown as a single entity in FIG. 1, the present invention may accommodate multiple operation centers in multiple geographical locations to provide failure recovery and to provide services over geographically diverse locations. A variety of services are provided by operation center 101 to support its operations and to display systems 102. For example, operation center 101 populates and maintains a current and archival database, which includes status, content, fault and maintenance logs, and other data of display systems 102.

Display systems 102 may be implemented using LED signboards, such as those disclosed in (i) U.S. Pat. No. 6,639,574, entitled “Light Emitting Diode Display” to P. Scheibe, filed Jan. 9, 2002 and issued Oct. 28, 2003, and (ii) U.S. patent application, entitled “Method for Compensating for a Chromaticity Shift due to Ambient Light in an Electronic Signboard,” Ser. No. 11/836,104, filed Aug. 8, 2007. The disclosures of U.S. Pat. No. 6,639,574 and U.S. patent application Ser. No. 11/836,104, are incorporated herein by reference in their entireties to provide background information for such display systems. The present invention imposes no limitations on the quantity, locations and types that may be used to implement display systems 102.

Client services system 103 provides means for the advertising content to be communicated to operation center 101 by customers or their designees. Personnel at operation center 101 may review the content for its appropriateness and quality. An audit trail of contents shown on display systems 102, timing, fault conditions and other pertinent information may be kept in one or more databases at operation center 101. The databases at operation center 101 may be available for queries and for construction of reports, as necessary, through client services system 103. In one implementation, queries and reports may be generated at operation center 101.

FIG. 2 shows, in further detail, the services and operations of operation center 101 of FIG. 1's advertising support system 100. As shown in FIG. 2, the design and architecture of operation center 101 allow an open-ended set of services, which includes: (a) time service 201, (b) status and fault display service 202, (c) communications service 203, (d) database 204, (e) presence management service 205, and (f) security service 206,

Time service 201 provides a system time service to the local network at each geographical location of each component of the system (e.g., at any display at display system s102). Time service 201 allows synchronization of the local times for various applications in the system (e.g., for use in conjunction with time-stamps associated with records in databases of operation center 101, and for controlling display systems 102). Time service 201 can be synchronized to a widely recognized national standard. Local time may be kept such that the typical error does not exceed five milliseconds relative to the national standard.

Status and fault display service 202 provides a real-time display of the current state of any display in display systems 102 for up to, for example, five days. Status and fault display service 202 may remain available even under a failure condition, by deploying a combination of batteries, uninterruptible power supplies (UPS) and generators (e.g., gasoline, diesel, or propane powered).

Communications service 203, which provides pertinent current data synchronous with the operation center database. Data in communications service 203 may be kept either at the display system 102, or on portable computers that can be carried to any display in display systems 102. Communications service 203 connects to the network within display systems 102 to provide logging and control. When a link failure occurs, the data in communications service 203 may be used to either restart or continue operation (depending on the operation policy) of affected displays in display system 203.

Database 204 provides highly reliable data storage and retrieval services, with a down time that is designed not to exceed, for example, five minutes per year. Database 204 is provided sufficient redundancy to allow for maintenance without interruption of services.

Presence management 205 provides access to personnel at operation center 101 through current and archival lists of operation center on-duty personnel maintained in database 204.

Security service 206 includes physical, communications and information access security services. Physical security service monitors intrusion, water and fire alarm systems at each component of the system. All control points are provided with personnel entrance and exit monitors and controls. Communication security service monitors the status of wide-area communications and maintains a record of the status at least once every hour. Failure events are recorded at the time of sensing. All communications between operation center 101 and display systems 102 are encrypted and monitored to prevent and to detect any tampering by undesired parties. Information access security service maintains a layered security structure to protect access to all information associated with the system.

As discussed above, client services system 103 provides access to data stored in operation center 101 of FIG. 1's advertising support system 100. Client services system 103 allows remote access by properly authorized and authenticated clients of operation center 101 (or customers) to access a network interface at operation center 101 to the database. The interface may be a network connection (“operation center interface”) that is flexible enough to allow not only customers and clients, but also operation center personnel and display systems 102 to provide services to themselves, and the public. The operation center interface manages all access control, including authentication, authorization and access logging.

The principal access provided by the operation center interface is a “web service,” which is a software system that is designed to support machine-to-machine interaction over a network, according to one aspect of the web service operations. This aspect of the web service allows applications and network-enabled devices to easily communicate with one another and to combine their functionalities to provide services to each other. This aspect of the web service may be accomplished with one or more software languages that are mostly application independent. Some examples of suitable languages that may be used generally or for specific applications include (a) Extensible Markup Language (XML); (b) Simple Object Access Protocol (SOAP), which is a protocol for exchanging XML-based messages over a network; (c) Synchronized Multimedia Integration Language (SMIL), which is an XML-based language, may be used to represent the ordering and timing of how multimedia (pictures, text, audio, etc.) is to be presented to an observer; and (d) Multimedia Messaging Service (MMS), which is a subset of SMIL, may be used for used for providing multimedia services to cellular telephones and other handheld or portable devices. SMIL is also useful to represent playlists, video clips and other multimedia. Machine-to-machine web services may be used, for example, to transfer current and archival play lists, content, fault logs, fault resolution logs and visual status monitor images between database 204 in operation center 101 and a computer in any of the components of display systems 102 and operation center 101 itself.

Another aspect of the web service that can be used by clients and customers of operation center 101 includes remotely-located machines that allow users (e.g., marketing, sales, accounting, customer service, and content control personnel, select clients and the public) to access applications. The applications may produce client-specific material to a user's web interface (e.g., a browser), a videophone, or another appliance that need not be web-associated. In one embodiment, the services available to each user depend on their credentials (e.g., login name and password or digital certificate). For example, trial playlist submission may be available only to content control personnel, the fault log may be available only to engineering department personnel, and statement and invoice generations may be available only to accounting personnel.

These aspects of the web service provide separation of management, maintenance and control of the web service between operation center 101 and its clients, so that an open-ended extension of services may be provided to others, such as the clients' customers and associates, service providers and web designers.

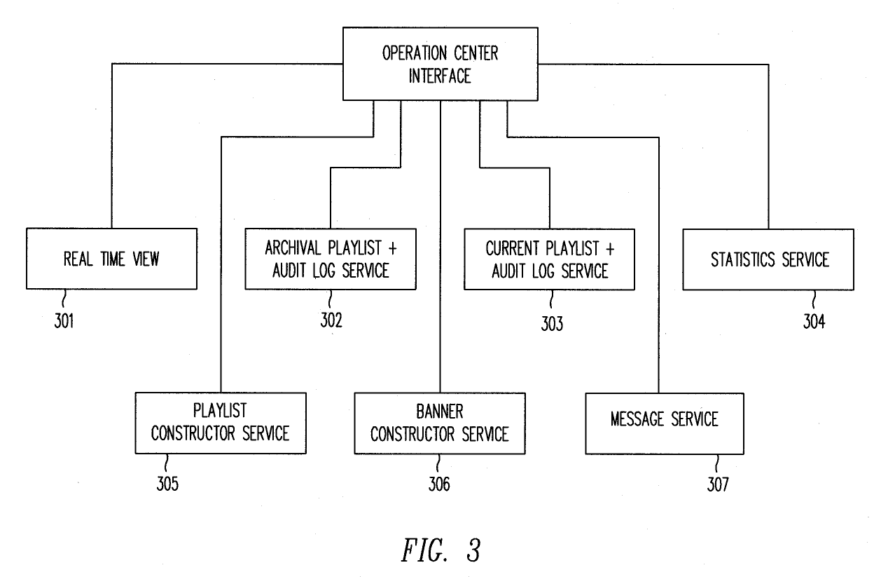

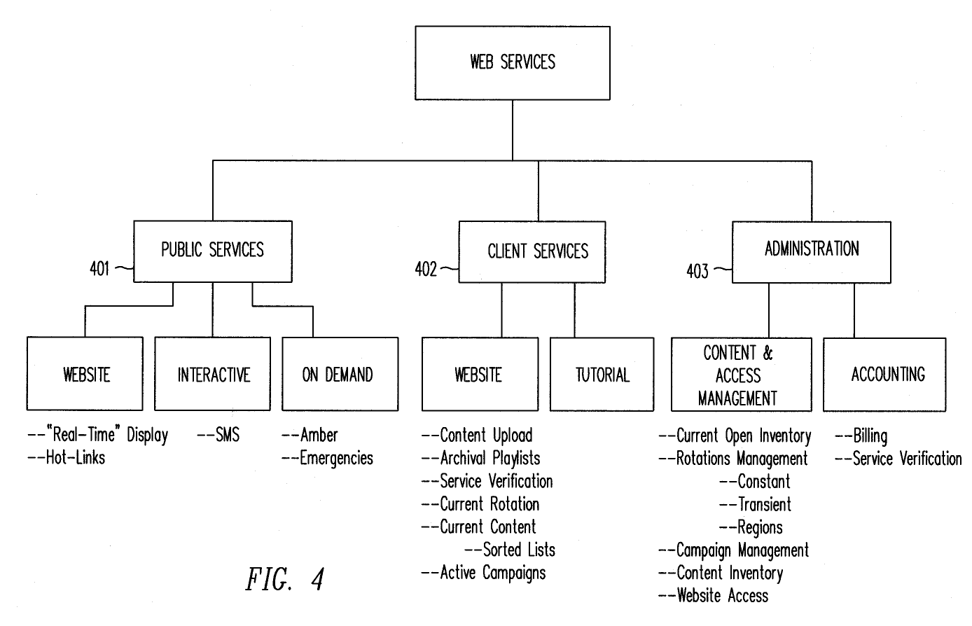

FIG. 3 shows exemplary applications available in client services system 103, which provides access to data stored in operation center 101 of FIG. 1's advertising support system 100. As shown in FIG. 3, examples of the web service applications include (a) real-time view 301, (b) archival playlist and audit log service 302, (c) current playlist and audit log service 303, (d) statistics service 304, (e) playlist constructor service 305, (f) banner constructor service 306, and (g) message service 307.

Real time view 301 provides a sequence of images that is approximately synchronized with the designated displays in display systems 102 (to within a second, but only after the images are actually shown on their designated electronic billboard displays). Real time view 301 may be a web application that is initiated by a user using a web browser. The application may be customized to the user according to the privileges granted to the user, which are determined at the time the user logs-in (if necessary). The user may be asked to select from a menu a particular display system in display systems 102, along with a selection of presentation forms (e.g., “real-time” thumbnails of last few images, full-size “real-time” motion or current image). On selection, the selected images are presented. Other functions, such as clicking on a given image to stop the updating process, presenting the still image, and resuming the updating process by another mouse click, may be provided.

In one implementation, real time view 301 interacts with the operation center interface to obtain either the current image or a sequence of images, as selected by the user. Forward buffering of the “real-time” sequence may be provided by the operation center interface, using the playlist associated with the images and pointers to the image files. In addition, the operation center interface maintains status information, including identification of the current playlist (to avoid showing a stale image sequence), and indicators of server or network loading, so as to signal any need to skip images in the presentation.

Archival playlist and audit log service 302 is an application which provides access to a customized selector, which allows selection and subsequent presentation of formatted archival playlists and audit logs. This application may be initiated by a user using a web browser. As in real time view 301, this application may be customized to the user according to the privileges granted to the user, which are determined at the time the user logs-in (if necessary). The user may also be asked to select from a menu a particular display system in display systems 102, along with a selection of presentation forms (e.g., “real-time” thumbnails of last few images, full-size “real-time” motion or current image). Data time span and report complexity are also selectable.

In one implementation, archival playlist and audit log service 302 interacts with the operation center interface to obtain archival playlists, fault description, fault resolution and audit logs. Since the requested time span may include the lifetime of several playlists, data made available includes a key to each playlist and a table of included playlists with the proposed and actual begin and end times. The retrieved data is formatted and made available to the browser with options to print, to store or to perform other suitable further processing, as appropriate.

Current playlist and audit log service 303 is an application which provides access to a customized selector, which allows selection and subsequent presentation of formatted current playlists and audit logs. This application may be initiated by a user using a web browser. As in real time view 301, this application may be customized to the user according to the privileges granted to the user, which are determined at the time the user logs-in (if necessary). The user may also be asked to select from a menu a particular display system in display systems 102, along with a selection of presentation forms (e.g., “real-time” thumbnails of last few images, full-size “real-time” motion or current image, motion, current image). Data time span and report complexity are also selectable. In one implementation, current playlist and audit log service 303 interacts with the operation center interface to obtain the current playlist, fault description, fault resolution and audit logs.

Statistics service 304 provides access to a summary of the times and statistics of actual showings of images. For example, statistics may be obtained on a selected set of displays of display systems 102, of a selected set of images, from a chosen start date-time to an end date-time. Image selection can be made, for example, based on a list of images, a list of customers, a list of creative entities, or any combination of images, customers and creative entities. The statistics application may be customized to the user according to the privileges granted to the user, which are determined at the time the user logs-in (if necessary). In one implementation, the user may request a document report in a specified format (e.g., XML or CSV) that can be used as input to a billing application.

In one implementation, statistics service 304 application interacts with the operation center interface to obtain archival playlists, fault logs, and audit logs. Since the requested time span may include the lifetime of several playlists, data made available includes a key to each playlist and a table of included playlists with the proposed and actual begin and end times. Access to archival visual status monitor images spanning a few seconds at the beginning and a few seconds at the end of each fault may also be provided on demand.

Playlist constructor service 305 allows a user to construct a proposed playlist and, if appropriate, to submit the completed playlist to operation center 101. Playlist constructor service 306 is a web application that may be initiated by a user (primarily, for example, by a content control personnel) using a web browser. This application may be customized to the user according to the privileges granted to the user, which are determined at the time the user logs-in (if necessary). Playlist constructor service 305 is a moderately complex application that involves a calendar, interaction with playlist constraints, connections between customers, images and image sources, ability to preview choices and other operations.

In one implementation, playlist constructor 305 interacts with the operation center interface to obtain image lists and archival playlists. Since the requested time span may include the lifetime of several playlists, data made available includes a key to each playlist and a table of included playlists with the proposed and actual begin and end times. Additionally, the application allows submission of the completed proposed playlist to the operation center, and viewing and possible revocation of the proposed playlist.

Banner Constructor service 306 is an application for constructing proposed banners and, if appropriate, to submit the completed banner to operation center 101. Banner constructor service 306 is a web application that may be initiated by a user (primarily, for example, by a content control personnel) using a web browser. This application may be customized to the user according to the privileges granted to the user, which are determined at the time the user logs-in (if necessary). Banner constructor service 306 is a moderately complex application that involves a calendar, interaction with playlist constraints, connections between customers, images and image sources, ability to preview choices and other operations.

In one implementation, banner constructor service 306 interacts with the operation center interface to obtain image lists and archival playlists. Since the requested time span may include the lifetime of several playlists, data made available includes a key to each playlist and a table of included playlists with the proposed and actual begin and end times. Additionally, the application allows submission of the completed proposed banner to the operation center, and viewing and possible revocation of the proposed banner

Message service 307 is an application that instantiates a message service for a customer that wishes to have an operation center client (e.g., a marketing company) handle incoming messages from viewers who respond to the displayed content. The viewer may respond by directing a message to the operating center client using either a Common Short Code (CSC, e.g., a four to six digit number or character string) or Common Long Code (CLC, e.g., a fully-qualified telephone number) to the message service, depending on whether Short Message Service (SMS, typically on cellphone) or Plain Old Telephone Service (POTS) is used. Hits per unit time interval or other statistics may be collected. In some instances an acknowledgment or other required reply may be provided to the responder either via SMS or voice automation on POTS, as required by the incoming message source. A game, drawings, phone number, URL or other information may also be included in a reply. Alternatively, message service 307 may provide a “hot link” service, whereby the viewer responds by following a link (e.g., a URL to a web page, or means displayed on the image to allow the viewer to click on) provided in the displayed content. The processing of the hot link hit is analogous to the processing of an SMS message discussed above. In some cases, a banner may be generated and placed on the displayed image, to respond to a reply or to statistics of received replies.

In one implementation, message service 307 accesses the operation center interface to obtain information from the active playlist.

FIG. 4 provides an overview of examples of applications that can be provided under the web service, according to one embodiment of the present invention. As shown in FIG. 4, applications under the web service may be grouped, for convenience, into “public services 401,” “client services 402” and “administrative services 403.”

Public Services 401 allows public users of web browsers (e.g., users of desktop computers, portable computers, third-generation cellular telephones) to access the web service without access limitation. Client Services 402 provides services to authorized and authenticated clients of the operation center that are users of web browsers under access control (e.g., login name and password or digital certificate). Administration Services 403 provides services to authorized and authenticated management and operational personnel under access control.

Some operation center interface services are (a) a list of the display systems that are available for consideration (“display_inventory”, available to client services 402 and administrative services 403), (b) a schedule giving the names of images that are to be shown in the immediate future (“current_content_queue”, available to client services 402), (c) a list of the images that are available for use (“content_inventory” available to client services 402), (d) an ability to download a given image (“content_fetch”, available to public services 401 and client services 402), (e) the current status of a display system (“current_display_status”, available to client services 402 and administrative services 403) and (f) the dimensions of the pixel array in a display system (“display_dimensions”, available to client services 402 and administrative services 403), (g) a log of images previously displayed and corresponding display status (“display_log”, available to public services 401, client services 402 and administrative services 403), and (h) the time range of the available log of the images previously displayed and those scheduled to be displayed in the immediate future (“extent_log_queue,” available to client services 402).

The above detailed description is provided to illustrate specific embodiments of the present invention and is not intended to be limiting. Numerous variations and modifications within the scope of the present invention are possible. The present invention is set forth in the accompanying claims.

I claim:

1. An advertising support system, comprising:
One or more electronic display systems;
an operation center capable of data communication with the electronic systems over a computer network, the operation center ensuring that content is displayed in each of the electronic display system at appointed times; and
a client service system communicating with the operation control center over the computer network to provide data for operating the display systems and to retrieve data relating to the electronic display systems.

2. An advertising support system as in claim 1, wherein the computer network comprises a wide-area network.

3. An advertising support system as in claim 1, wherein the display systems are located in different geographical locations.

4. An advertising support system as in claim 1, wherein each display system comprises one or more electronic billboard.

5. An advertising support system as in claim 1, further comprising a second operation center capable of data communication with the display systems, the first and second operation center include redundancy, such that operation support for the display systems remain uninterrupted even when a failure condition arises in one of the operation centers.

6. An advertising support system as in claim 1, wherein the operation center maintains a current database for tracking one or more of status, content, fault and maintenance logs of the display systems.

7. An advertising support system as in claim 1, wherein the operation center provides a time service to the display systems, so as to synchronize each display system to within a predetermined time relative to a time maintained at the operation center.

8. An advertising support system as in claim 7, wherein the time maintained at the operation center is synchronized to a national time standard.

9. An advertising support system as in claim 1, wherein the operation center further provides a status display service to keep track of operational conditions of each display in each display system.

10. An advertising support system as in claim 9, wherein the status display service also keeps track of fault conditions in each display in each display system.

11. An advertising support system as in claim 1, wherein the operation center provides a communication service for communicating programming data to each display in each display system.

12. An advertising support system as in claim 11, wherein the communication service provides the programming data over the computer network.

13. An advertising support system as in claim 1, wherein the operation center maintains one or more databases to maintain programming, control and statistical data relating to operations of the display systems.

14. An advertising support system as in claim 13, wherein the databases also maintains accounting data relating to the operations of the display system.

15. An advertising support system as in claim 1, wherein the operation center provides a presence management service that allows access to on-duty personnel at the operation center.

16. An advertising support system as in claim 1, wherein the operation center provides a security service that controls and monitors physical and data communication security operations at the operation center.

17. An advertising support system as in claim 16, wherein the security service further provides security protection for data maintained at the operation center.

18. An advertising support system as in claim 1, wherein communication between the display systems and the operation center are machine-to-machine.

19. An advertising support system as in claim 18, wherein the communication between the display systems and the operation center are facilitated by using a machine-independent protocol specification language.

20. An advertising support system as in claim 1, wherein communication between the operation center and the client service system is carried out over a network connection.

21. An advertising support system as in claim 1, wherein the client service system maintains a web service for access by a user via a web interface.

22. An advertising support service as in claim 21, wherein access to the web service is controlled.

23. An advertising support service as in claim 22, wherein each user is assigned a set of privileges granted at the time of signing onto the web service.

24. An advertising support service as in claim 21, wherein the web service provides an application that allows the user to obtain a real time view of images being display at any of the display in the display systems.

25. An advertising support service as in claim 21, wherein the web service comprises an archival playlist service which allows the user to access a playlist of images previously displayed on any displays of the display systems within a specified previous time span.

26. An advertising support service as in claim 25, wherein the archival playlist service also provides an audit log of the playlist accessed.

27. An advertising support service as in claim 21, wherein the web service comprises a current playlist service which allows the user to access in real time a current playlist of images being displayed on any displays of the display systems.

28. An advertising support service as in claim 27, wherein the current playlist service also provides an audit log of the playlist accessed.

29. An advertising support service as in claim 28, wherein the web service comprises a statistics service which provides statistical data relating to the programming and operations of any display in the display systems.

30. An advertising support service as in claim 29, wherein the statistics service further provides customized reports to the user.

31. An advertising support service as in claim 28, wherein the statistics service includes access control such that only data within the user's privileges is provided to the user.

32. An advertising support service as in claim 21, wherein the web service comprises a playlist constructor service which allows a user to construct a playlist of images to be played on any display device of the display systems.

33. An advertising support system as in claim 32, wherein the playlist constructor service further allows the user to upload the constructed playlist to be played on the display device.

34. An advertising support system as in claim 33, wherein the web service submits the uploaded playlist for review by operation center personnel.

35. An advertising support system as in claim 21, wherein the web service comprises a banner constructor service which allows a user to construct a banner to be overlaid on a sequence of images on any display device of the display systems.

36. An advertising support system as in claim 35, wherein the banner constructor service further allows the user to upload the constructed banner to be used on the display device.

37. An advertising support system as in claim 33, wherein the web service submits the uploaded banner for review by operation center personnel.

38. An advertising support system as in claim 21, wherein the web service further comprises a message service that handles messages from viewers responding to an image of the display systems,

39. An advertising support system as in claim 38, wherein the message is sent via a response mechanism displayed on the image.

40. An advertising support system as in claim 39, wherein the response mechanism comprises a universal resource locator (URL) accessible through a web interface.

41. An advertising support system as in claim 39, wherein the response mechanism comprises sending a message via a cellular telephone network.

42. An advertising support system as in claim 41, wherein the message is sent using the Common Short Code convention.

43. An advertising support system as in claim 38, wherein the message service allows the received message to be processed by a client of the operation center.

44. An advertising support system as in claim 43, wherein the client of the operation center provides a reply to the message through the message service.

45. An advertising support system as in claim 44, wherein the reply comprises a link for the user to obtain further information relating to the subject matter of the image being displayed.

46. An advertising support system as in claim 44, wherein the reply provides a mechanism whereby an on-line commercial transaction may be carried out.

47. An advertising support system as in claim 3 8, wherein the message service compiles statistics based on the messages received in response to the image being displayed in the display systems.

48. An advertising support system as in claim 47, wherein the message service generates a banner to be overlaid on images being displayed on displays in the display systems, based on the statistics being compiled on the received messages.
